(19) United States
(12) Patent Application Publication
(10) Pub. No.: US 2012/0078738 A1
(43) Pub. Date: Mar. 29, 2012

(54) Electronic registration systems for items purchased under a gift registry and/or for items to be distributed post-sale, and associated methods

(75) Inventor: Maridee Joy Maraz, Sammamish, WA (US)

(73) Assignee: Nintendo of America Inc., Redmond, WA (US)

(21) Appl. No.: 12/923,483

(22) Filed: Sep. 23, 2010

(51) Int. Cl. G06Q 20/00; G06Q 10/00

(52) U.S. Cl. 705/21; 705/302

(57) ABSTRACT

The exemplary embodiments described herein relate to the field of electronic registration (ER) of purchased products and, more particularly, to an improved electronic registration system that tracking and validating return/warranty eligibility for items purchased from a gift registry and/or to be given to a recipient at a future time, e.g., remote from the actual purchase date. If it is determined that a product is sold as a part of a gift registry, for example, the “start date” of the return/warranty eligibility period may be effectively set as the event date rather than the actual item purchase date and/or event date validation may be selectively performed in place of sale date validation when evaluating return/warranty eligibility for such items. As a result, it is possible to at least partially restore an otherwise diminished return/warranty eligibility period for a purchased, but not immediately gifted, item.

### TECHNICAL FIELD

The exemplary embodiments described herein relate to the field of electronic registration (ER) of purchased products and, more particularly, to an improved electronic registration system that enables tracking and validating return/warranty eligibility for items purchased from a gift registry and/or to be given to a recipient at a future time, e.g., remote from the actual purchase date. In certain exemplary embodiments, the “start date” of the return/warranty eligibility period is effectively replaced with the event date rather than the actual item purchase date so as to help at least partially restore an otherwise diminished return/warranty eligibility period for a purchased, but not immediately gifted, item.

### BACKGROUND AND SUMMARY

Electronic registration (ER) of product transactions recently has become available for the purpose of reducing unauthorized returns of purchased products and/or unauthorized warranty repair on purchased products. Electronic product registrations systems provided for this purpose are disclosed in, for example, U.S. Pat. Nos. 5,978,774; 6,018,719; and 6,085,172, the disclosures of which are all incorporated by reference herein in their entirety. The electronic registration system relies on the use of a unique identifier, such as a serial number linked to a UPC (and/or RFID) or its equivalent, for each product that is purchased. The serial number is obtained at the point of sale for inclusion in a registration database, together with other information, such as a date of transaction. This database can then be accessed in connection with an attempted product return/warranty transaction for the purpose of determining if the product qualifies for return/warranty under applicable return/warranty criteria under which the product was originally sold. Such electronic systems may also be used in connection with repair and/or exchange transactions, in addition to returns, by enabling an accurate determination as to whether the product qualifies for any of these actions under the appropriate policies and criteria under which the product was originally sold.

The ER system uses pre-established return/repair policies and procedures that are programmed into the ER system so that the system can perform a check when a product is presented for return to determine if the product qualifies for return, replacement and/or warranty repair based on sales transaction information available in the ER system for the particular product at issue and based on the retailer and manufacturer's return and warrant policies. Thus, known ER systems include a database of return qualification information (or warranty/replacement criteria) for various manufacturers and/or retailers which enables the system to make an accurate determination with respect to whether or not a product actually qualifies for return (or warranty/replacement) based on the appropriate criteria and at the time the product is actually presented for return. Such ER systems have greatly reduced improper and fraudulent returns and warranty claims.

While such ER systems have proven to be very useful in their current forms, additional improvements in the system are still desired to make such ER systems more flexible in operation and in order to benefit customers, retailers, and manufacturers. For example, when a prospective bride and groom plan their wedding, when a pregnant mother prepares for her new arrival, etc., gift registries are common ways to communicate, coordinate, and in a way track gift-giving from friends and family. In setting up a new registry, the prospective gift recipient(s) enter(s) in personal information such as, for example, the event date (e.g., wedding date, baby shower date, anticipated child due date, graduation date, etc.), unique identifying information about the potential recipient (e.g., name, address, contact information, potential gift-givers), etc. The prospective gift recipient(s) also adds items of interest to the list for the potential gift-givers to browse at a later time. The gift registry system records and stores this and possibly other information for gift purchasers, oftentimes updating the list of items as the gift purchasers select items from the list and purchase them.

Gift registries typically have uniquely identifiable registry numbers and, as alluded to above, each gift registry typically includes a list of the UPCs and product descriptions of items the prospective gift recipient would like to receive. When friends or family purchase an item listed in a gift registry, the retail cashier typically reads (e.g., scans or otherwise enters) the registry number (which sometimes is a bar code) and then enters each of the UPCs being purchased in each transaction. A database system that oftentimes is internal to the store or chain of stores tracks which items were requested by the gift recipients and which of those items have been purchased, e.g., to reduce the likelihood of “double gifting” the same item. Gift purchasers are often provided with retailer gift receipts that include the product UPC and the transaction number, omitting the price of the item(s) being purchased.

Although predefined and customizable return/warranty policies may be used with ER systems, further improvements to such ER systems would be desirable, e.g., when items are to be sold as a part of a gift registry or to be subsequently distributed post-sale at a certain time/date or as a part of an event, etc. For example, challenges may arise when registries are created weeks or months before an event date. Gift purchasers buy gifts from the registry in advance of the wedding, birth, or other event and often wait to present their items until the event date. This advance purchase may, in turn, reduce the return/warranty eligibility of the item, e.g., when the return/warranty eligibility is based on the gift purchase date rather than the event date.

Thus, it will be appreciated that there is a need in the art for improved ER techniques that provide techniques for tracking and validating return/warranty eligibility for items purchased from a gift registry and/or to be given to a recipient at a future time. It also will be appreciated that there is a need in the art for improved ER techniques that help address the problem of diminished return/warranty periods when an item is purchased at a time in advance of when it ultimately is given to the recipient.

One aspect of certain exemplary embodiments relates to techniques for tracking and validating return/warranty eligibility for items purchased from a gift registry and/or to be given to a recipient at a future time, e.g., remote from the actual purchase date.

Another aspect of certain exemplary embodiments relates to techniques for at least partially restoring the length of a return/warranty period when an item is purchased at a time in advance of when it ultimately is given to the recipient, where such a return/warranty period otherwise would be diminished because of this time period between when the product is purchased and when the product is ultimately provided to the recipient.

Another aspect of certain exemplary embodiments relates to effectively setting the “start date” of the return/warranty eligibility period as the event date rather than the actual item purchase date and/or selectively performing event date validation in place of sale date validation when evaluating return/warranty eligibility.

According to certain exemplary embodiments, a method of processing a product at a point-of-sale (POS) location is provided. A unique identifier of an item presented in connection with a return or warranty request is received. In an electronic registration (ER) database of an ER system, a record that corresponds to the presented item is located, with the record indicating an original sale date of the item and an applicable return or warranty policy for the presented item. Based at least in part on the record, it is determined whether the presented item was sold in connection with a gift registry. When it is determined that the presented item was sold in connection with a gift registry, it is further determined whether the presented item qualifies for the return or warranty request using an event date associated with the gift registry rather than the original sale date of the item. An indication as to whether the presented item qualifies for the return or warranty request is provided.

According to certain exemplary embodiments, a method of processing a product at a point-of-sale (POS) location is provided. A unique identifier of an item presented in connection with a return or warranty request is received, with the item having been previously sold in connection with a gift registry. A registry identifier associated with the gift registry is received. In an electronic registration (ER) database of an ER system, a first record that corresponds to the presented item is located, with the first record indicating an applicable return or warranty policy for the presented item. In a gift registry database, a second record indicating an event date based on the registry identifier is located. It is determined whether the presented item qualifies for the return or warranty request using the event date and the applicable return or warranty policy for the presented item. An indication as to whether the presented item qualifies for the return or warranty request is provided.

According to certain exemplary embodiments, a product return/warranty validation system is provided. An electronic registration (ER) system includes programmed logic circuitry and an ER database, with the ER database storing records corresponding to sold items, and with each said record indicating an original sale date of the item and an applicable return or warranty policy for the item. The programmed logic circuitry is configured to: (a) receive a unique identifier of an item presented in connection with a return or warranty request, (b) locate, in the ER database, a record that corresponds to the presented item, (c) determine, based at least in part on the record, whether the presented item was sold in connection with a gift registry, and (d) when it is determined that the presented item was sold in connection with a gift registry, further determine whether the presented item qualifies for the return or warranty request using an event date associated with the gift registry rather than the original sale date of the item.

According to certain exemplary embodiments, a product return/warranty validation system is provided. An electronic registration (ER) system includes programmed logic circuitry and an ER database, with the ER database storing records corresponding to sold items, and with each said record indicating an original sale date of the item and an applicable return or warranty policy for the item. The programmed logic circuitry is configured to: (a) receive a unique identifier of an item presented in connection with a return or warranty request, the item having been previously sold in connection with a gift registry, (b) receive a registry identifier associated with the gift registry, (c) locate, in the ER database, a first record that corresponds to the presented item, (d) locate, in a gift registry database, a second record indicating an event date based on the registry identifier, and (e) determine whether the presented item qualifies for the return or warranty request using the event date and the applicable return or warranty policy for the presented item.

In certain exemplary embodiments, it may be determined whether the presented item qualifies for the return or warranty request using the original sale date of the item when it is determined that the presented item was sold not in connection with a gift registry.

In certain exemplary embodiments, it may be determined whether the presented item qualifies for the return or warranty request using the original sale date of the item, and the determination as to whether the presented item qualifies for the return or warranty request using the original sale date of the item may be overridden and instead it may be determined whether the presented item qualifies for the return or warranty request using the event date associated with the gift registry rather than the original sale date of the item when it is determined that the presented item was sold in connection with a gift registry. In addition, in certain exemplary embodiments, the overriding may be practiced only when the original sale date of the item is earlier in time than the event date associated with the gift registry.

In certain exemplary embodiments, the determining of whether the presented item was sold in connection with the gift registry may be practiced by consulting a gift registry database identified in the record. The gift registry database may in certain exemplary instances be separate form the ER database. Personal information regarding the item recipient(s) and the purchaser(s) of the item may not be provided to the ER database in certain exemplary instances.

It will be appreciated that these aspects and embodiments may be combined in various combinations and sub-combinations to achieve yet further exemplary embodiments. Also, it will be appreciated that the exemplary embodiments herein may be implemented as any suitable combination of programmed logic circuitry including, for example, hardware, software, firmware, etc. Instructions may be stored on a suitable non-transitory computer readable storage medium and, when executed, may perform method steps corresponding to those described herein.

### BRIEF DESCRIPTION OF THE DRAWINGS

These and other features and advantages will be better and more completely understood by referring to the following detailed of exemplary illustrative non-limiting implementations in conjunction with the drawings, of which:

FIG. 1 is a schematic block diagram illustrating an example of an overall electronic product registration (ER) system that may be used in accordance with an exemplary embodiment;

FIG. 2 is a high level flowchart of some of the main steps performed in accordance with prior electronic product registration (ER) systems;

FIG. 3 is an illustrative timeline that helps demonstrate how and why diminished return/warranty periods oftentimes are encountered when a gift registry is used;

FIG. 4 is an illustrative timeline that demonstrates how certain exemplary embodiments help address the problems associated with diminished return/warranty periods that oftentimes are encountered when a gift registry is used;

FIG. 5 is a simplified block diagram showing how an ER system may interact with an external gift registry database in accordance with certain exemplary embodiments;

FIG. 6 is a flowchart that shows an illustrative process for updating an ER database when an item is sold for a gift registry in accordance with certain exemplary embodiments; and

FIG. 7 is a flowchart that shows an illustrative process for handling a return/warranty request in accordance with certain exemplary embodiments.

### DETAILED DESCRIPTION

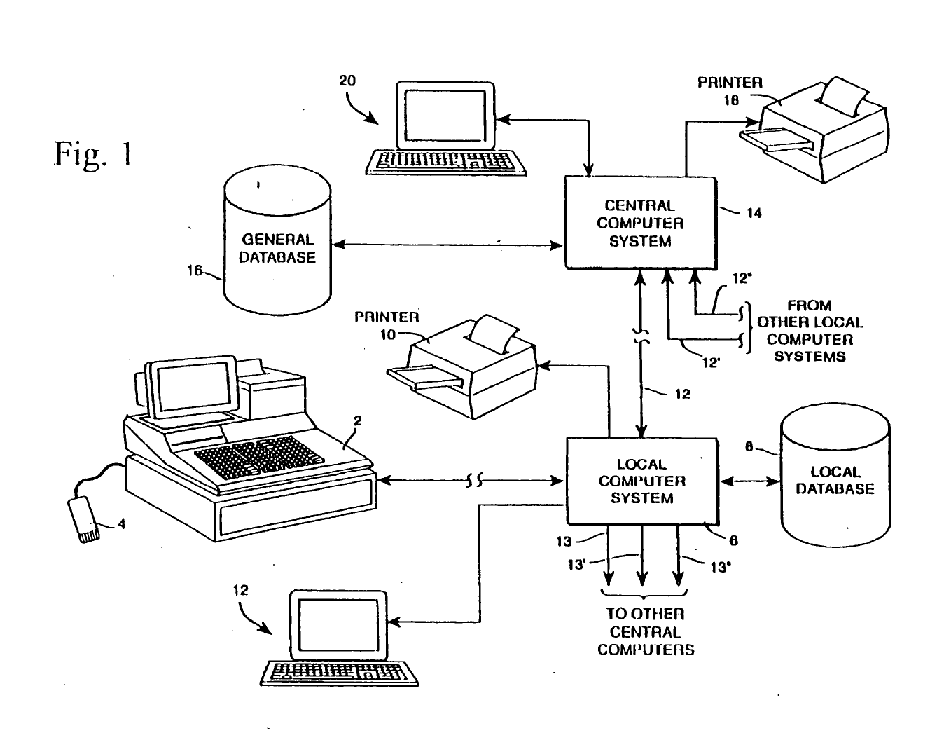

An example of one type of electronic product registration (ER) system that may be used in connection with the instant invention is illustrated in FIG. 1. Briefly, this example system includes a point of sale register 2 and an associated bar code scanner 4. The register 2 is preferably connected with a local computer system 6 in any suitable manner. In certain situations (e.g., single store retailers), it may be advantageous to have the local computer system 6 located in proximity to the register 2. For large chain stores, however, it may be advantageous to situate the local retailer computer 6 at a central location with links to the registers 2 at individual stores. The particular arrangement will depend on the preferences and circumstances of the specific retailer and may vary in accordance therewith.

The local retailer computer system includes an associated local database 8 for storing registration information. Additionally, a local printer 10 and an operator terminal 11 may be provided. The operator terminal may be used, for example, by a store clerk upon return of merchandise to locate pertinent sales information in the local database 8. The printer 10 may be used to produce hard copies of, for example, end-of-day sales reports and/or the like.

In the exemplary embodiment, a communication channel 12 is provided between the retailer computer system 6 and a central computer system 14. The central registration computer system may, for example, be an independent registration center computer system which electronically registers product transactions for a number of different retailers. In other words, the central computer system may be operated by a third-party service provider.

A general registration database 16 is associated with the central registration computer system 14 for storing transaction information from a plurality of retailer computer systems 6. Additionally, a printer 18 and an operator terminal 20 may be included with the central registration computer system 14. As discussed below in greater detail, the central registration computer system may maintain a number of data files pertaining to individual retailers, manufactures and the like. These data files include information applicable to the particular individual retailer, distributor, manufacturer or the like and are preferably maintained by that particular individual or entity. For example, a data file may contain specific return/warranty policy information applicable to that particular individual or entity.

It should be appreciated that the central computer system 14 is preferably intended to handle product registrations for a number of different manufacturers and/or other vendors. Accordingly, the general registration database may employ a structure wherein the product registrations for each participating vendor is maintained in separate areas. Alternatively, separate databases may be employed for each participating vendor. Of course, other data structures may be employed so long as the registration center is able to properly keep track of the product transaction information and particular return and/or warranty policies associated with each transaction.

As illustrated in FIG. 1, the central registration computer system 14 may have a number of additional communications links 12′, 12″, etc. for receiving information from other local computer systems. Thus, for example, a registration center may receive information from a number of different retailers. Additionally, the local computer system 6 may include a number of additional communication channels 13, 13′, 13″, etc. for connecting with other central computer systems. Accordingly, an individual retailer can electronically register products with a number of different registration databases, if desired. Furthermore, a number of communication channels 15, 15′, 15″, etc. can be provided for communications between the central registration computer system 14 and individual manufacturer computer systems and computer systems of third party service providers, law enforcement agencies and/or the like. Of course, a general access channel such as an Internet connection may also be made available for authorized access to the central computer system 14.

The electronic registration process begins when a customer brings merchandise to the register 2 for check-out. The sales clerk enters the SKU number which identifies the type of product involved in the transaction (e.g., Super Nintendo Entertainment System, Nintendo Game Boy, Nintendo N64, etc.) by, for example, scanning a UPC product code included on the product packaging. Of course, key entry or another technique for entering the SKU number may be used. Electronic registration might not be necessary for a substantial number of small commodity and/or disposable products (e.g., candy, diapers, cotton swabs, paperclips, household goods, beauty products, over-the-counter items, etc.) that are commonly sold by retailers. Accordingly, a check may be made, based on the type of product as identified by the UPC code, to determine whether this is a product for which electronic registration is desired. If so, the store associate is prompted to enter the serial number of the individual item.

The serial number may be entered, for example, by scanning a serial number printed on the packaging. Alternatively, the serial number as it appears on the product may be scanned through a window in the packaging. This alternative ensures that the individual product is identified even if it is mispackaged. Also, repackaging of returned merchandise would be simplified. Other techniques, such as key entry, may also be used. Because the UPC and serial number combination is unique to each individual product, it acts as individual production identification information.

Once the serial number is entered, a check may be made to ensure that the serial number is valid. If not valid, the store associate is again prompted to enter the serial number. This is repeated until a valid serial number is obtained. Once the serial number is verified, a local database may be updated with the serial number information and any other necessary or desired information. At minimum, however, the local database should include an indication of the date on which the transaction took place. Other information might include the price paid, the store associate responsible for the sale, and the like.

The serial number of the individual product is preferable printed as part of a written customer transaction receipt. The serial number may be printed adjacent the description and SKU number of the registered product. Thus, it will be a simple matter to correlate serial numbers with associated products, particularly when several registered products appear on a single customer sales receipt. Of course, additional information may be printed as well.

The date of the transaction will typically be printed at either the beginning or the end of the sales receipt, but may appear anywhere on the receipt. After the serial number is printed, a check is made to determine whether sales are complete. Ordinarily, this will be based on the store associate hitting a TOTAL button on the cash register. Thereafter, the central registration computer system 14 is contacted and the general registration database 16 is updated with the transaction information.

Inasmuch as ER systems are known, further specific details regarding ER systems themselves will not be provided herein except as needed for a complete understanding of the invention. As seen from the above description of an ER system, original policies are defined for products when they are first sent to the retailer by the vendor. The ER system preferably includes the policies of both the vendor and the retailer and enables the policies of both parties to be easily and conveniently enforced.

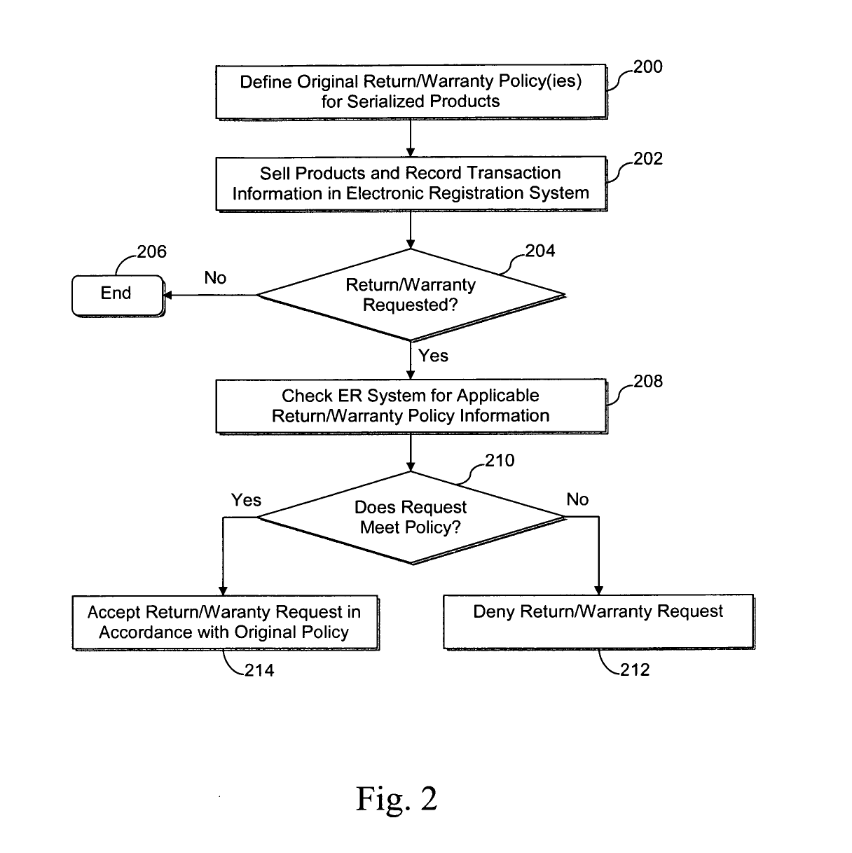

FIG. 2 shows the main steps performed in connection with conventional ER systems. As shown in FIG. 2, the return/warranty policy(ies) are defined for serialized products and entered into the ER system (step 200). The ER system uses the policies and the sales transaction information, as well as the date on which a return is requested, to determine if the product qualifies for return when presented for return. Thus, when the products are sold, the sales transaction is recorded in the ER database (step 202). If the consumer is satisfied with the product, then the process ends (step 206). On the other hand, if a return is requested (step 204), the ER system is accessed to obtain the return qualification information for the specific product being presented for return (step 208). In accordance with conventional ER systems, the return request is handled based on the return qualification information provided by the ER system based on the original policies under which the product was originally sold. Thus, based on the return qualification information provided by the ER system, a determination is made as to whether or not the product qualifies for return/warranty repair or the like (step 210). If the product does qualify for the action requested, the request can be honored by the retailer and the transaction can be completed (step 214). On the other hand, if the ER system indicates that the product does not qualify for the requested action, the customer is typically denied the return or warranty repair (step 212). Of course, the store clerk could decide, for some reason, to ignore the ER information and accept the product anyway.

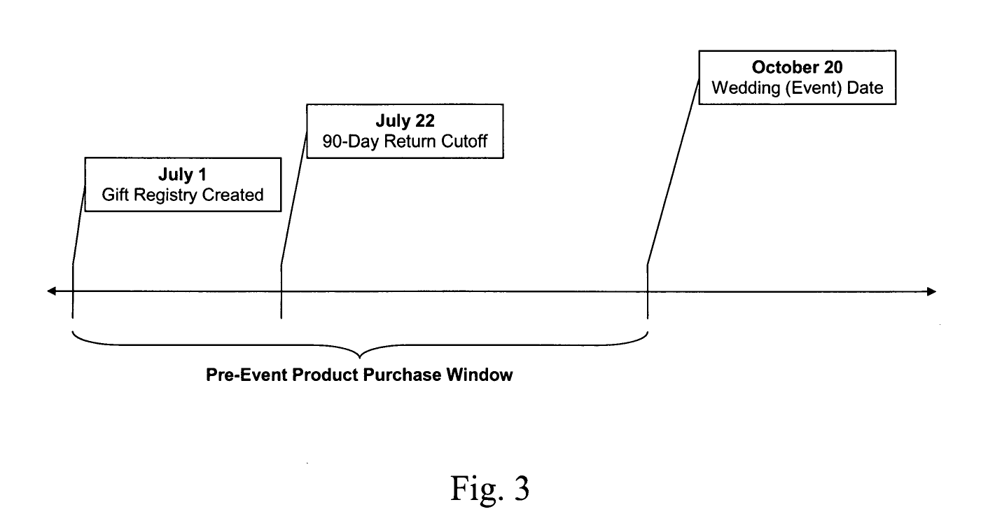

As indicated above, challenges may arise when registries are created weeks or months before an event date. For instance, gift purchasers often buy gifts from the registry in advance of the wedding, birth, or other event and often wait to present their items until the event date. This advance purchase may, in turn, reduce the return/warranty eligibility of the item, e.g., when the return/warranty eligibility is based on the gift purchase date rather than the event date. This kind of problem is described in connection with FIG. 3, which is an illustrative timeline that helps demonstrate how and why diminished return/warranty periods oftentimes are encountered when a gift registry is used. If, in accordance with the FIG. 3 example, a gift registry is set up by gift recipients on July 1 for a wedding planned for October 20 in a store with a 90-day return period for sold items, any gifts purchased before July 22 would be ineligible for return after the wedding date under the prevailing store policy. Because gift-givers may begin purchasing items to be gifted on or after the event date is initially announced and the gift registry setup, some of these items may not be eligible for return at all. Furthermore, in the FIG. 3 example, unless an item is purchased on or after the wedding date and delivered to the recipient on the same date, it will have a diminished return/warranty period. In the context of the FIG. 3 example, those items purchased between July 22 and October 20 will have this sort of diminished return/warranty period, with the severity of the reduction in return/warranty period depending on how close the purchase is to the actual October 20 wedding date and when the recipient(s) actually take possession of those items.

The problems of diminished or completely exhausted return/warranty periods may be exacerbated under a number of circumstances. For instance, newlyweds often wait to return gifts until after the wedding and after a honeymoon. Retailers often have shorter return periods for popular items such as, for example, electronics and power tools, which are oftentimes given as wedding gifts. Although the FIG. 3 represents the potential problems with diminished or completely exhausted return periods for a 90-day return policy, it will be appreciated that the problems may be even more extreme in the case of shorter (e.g., 30 day, 45 day, etc.) return policies. Of course, it also will be appreciated that the same or similar problems may be encountered with respect to warranty issues in addition to returns.

The inventor of the instant application has discovered that these and/or other problems may be addressed by effectively setting the “start date” of the return/warranty eligibility period as the event date rather than the actual item purchase date. In so doing, certain exemplary embodiments may help to provide unique techniques for tracking and validating return/warranty eligibility for items purchased from a gift registry and/or to be given to a recipient at a future time, e.g., remote from the actual purchase date. In the context of the FIG. 3 example, for a wedding event date of October 20, the return/warranty eligibility period would be overridden to be based on the October 20 date rather than the actual date of the purchase (e.g., if purchase date precedes the event date) according to certain exemplary embodiments.

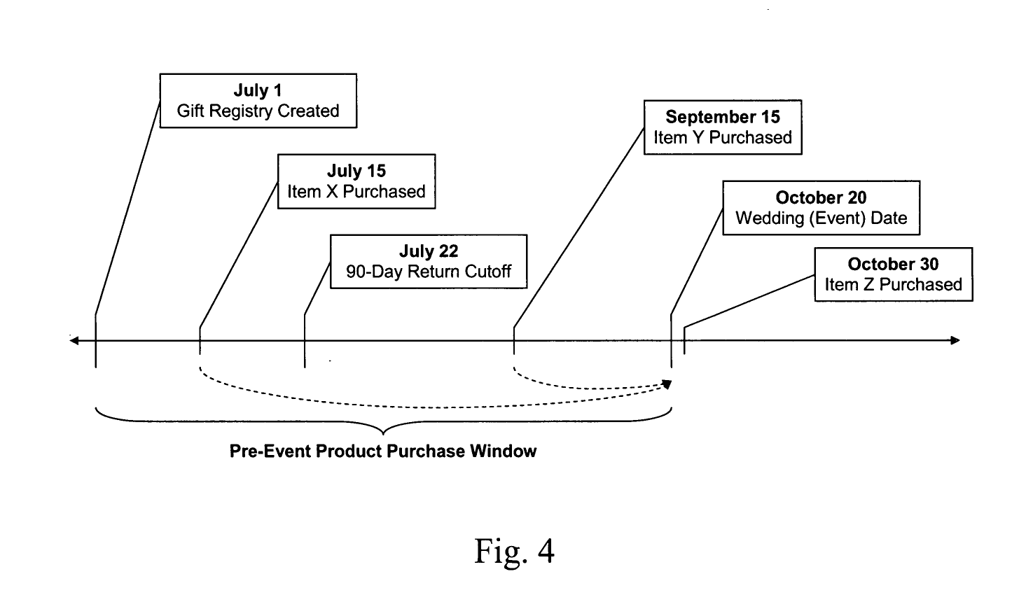

FIG. 4 is an illustrative timeline that demonstrates how certain exemplary embodiments help address the problems associated with diminished return/warranty periods that oftentimes are encountered when a gift registry is used. The illustrative scenario shown in the FIG. 4 example includes the hypothetical purchase of first, second, and third items X, Y, and Z, on July 15, September 15, and October 30, respectively. As can be seen in FIG. 4, items X and Y are sold before the wedding date, with item X being sold before the July 22 90-day return cutoff and with item Y being sold after the July 22 90-day return cutoff.

The dashed lines in FIG. 4 indicate that the effective sale date has been modified so as to correspond to the event date. Thus, items X and Y are effectively sold on the event date and thus have 90-days worth of return/warranty eligibility when they are given to the wedding couple. The earlier in time the item is purchased, the greater the amount of “restored” eligibility will be. In the extreme case of item X, there would have been no return/warranty eligibility if the effective sale date were not modified because it was actually sold before the July 22 90-day return cutoff date. The end result, however, will be that both items X and Y will have 90 days worth of return/warranty eligibility when they ultimately are gifted to the wedding couple on the event date.

In contrast with items X and Y, item Z is shown as being sold after the event date. In such a case, the 90-day return window may not be adjusted back to the wedding date even though it is sold a part of a registry. To move the effective sale date for item Z back from October 30 to October 20 actually would diminish the amount of time in the return/warranty eligibility period compared to actual sale date. This kind of modified processing for items purchased from a gift registry after an event date may sometimes be viewed as being advantageous because the wedding couple presumably could not have had the item before it was purchased and thus would not “punish” the wedding couple for the gift-giver's belated purchase.

Of course, it will be appreciated that certain exemplary embodiments advantageously may still track a complete product history that includes the original purchase date, the event date and all other elements of the transaction history for the item, e.g., by that product's unique identifier, for those items that are uniquely identified (e.g., using the UPC and Serial Number, RFID, etc.), e.g., using the ER database.

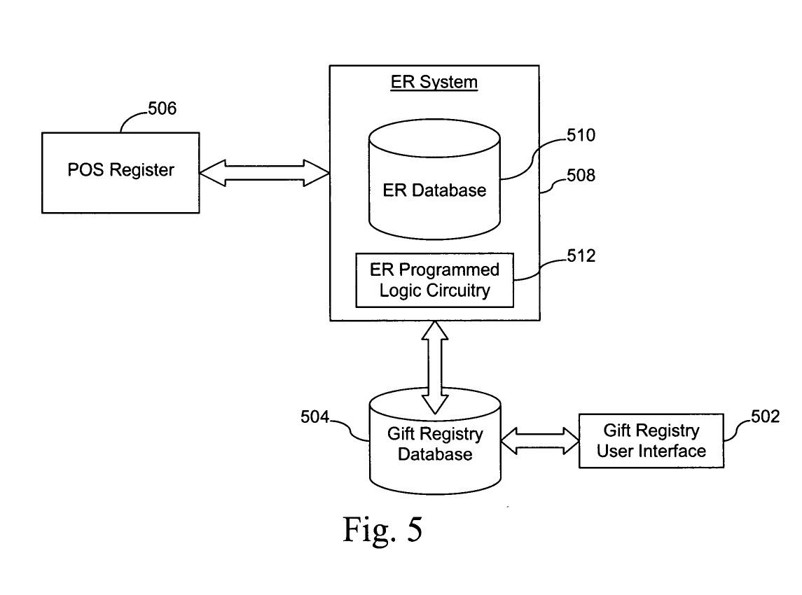

FIG. 5 is a simplified block diagram showing how an ER system may interact with an external gift registry database in accordance with certain exemplary embodiments. A would-be recipient may use a gift registry user interface 502 to create a profile, along with a list of items to be added to the registry. Items may be specified by having a would-be recipient scan barcodes or enter other identifiers of a product, select products from a list, etc. The profile may include information such as, for example, the name of the event, the date of the event, and/or personal information about the would-be recipient. A unique identifier may be created and associated with the profile and the list of items. Together, that and/or other information may be stored to a gift registry database 504. It will be appreciated that the gift registry user interface 502 may be provided in or remote from the location where the items are sold. For example, the gift registry user interface 502 may be accessed in a retail store, via the Internet, etc. It also will be appreciated that the gift registry database 504 may be provided for a particular store, for a chain of stores, etc., and need not necessarily be collocated with the gift registry user interface 502.

A POS register 506 also may be provided to the location. The register 506 may be in communication with a centralized ER system 508 that includes, for example, an ER database 510 and ER programmed logic circuitry 512. The ER system 508 may be external to the gift registry database 504 in certain exemplary embodiments. However, in certain other exemplary embodiments, the gift registry database 504 may be included in the ER system 508 and/or incorporated into a single ER database 510 itself (e.g., as separate but linked tables or in augmented tables thereof). In certain exemplary embodiments, the ER system 508 may be in communication with a plurality of different, internal and/or external gift registry databases 504 that may be, for example, maintained by individual stores, retail locations, e-tailers, manufacturers, etc. When the ER system 508 is in communication with plural gift registry databases 504, the gift registry databases 504 may be identified by a gift registry databases identifier. Individual registries of the one or more gift registry databases similarly may be uniquely identified by registry identifiers.

The ER programmed logic circuitry 512 may comprise at least one processor and a memory, for example, and may communicate with the POS register 506, e.g., to update the ER database 510 upon an item sale, provide information to the POS register 506 when a return/warranty request is made (e.g., following the querying of the ER database 510), etc. The same or separate ER programmed logic circuitry 512 may also coordinate between the ER system 508 and the gift registry database 504. For instance, the ER programmed logic circuitry 512 may help update and/or query the gift registry database 504 when a registered item is sold at the register 506 or presented for return or warranty service, etc.

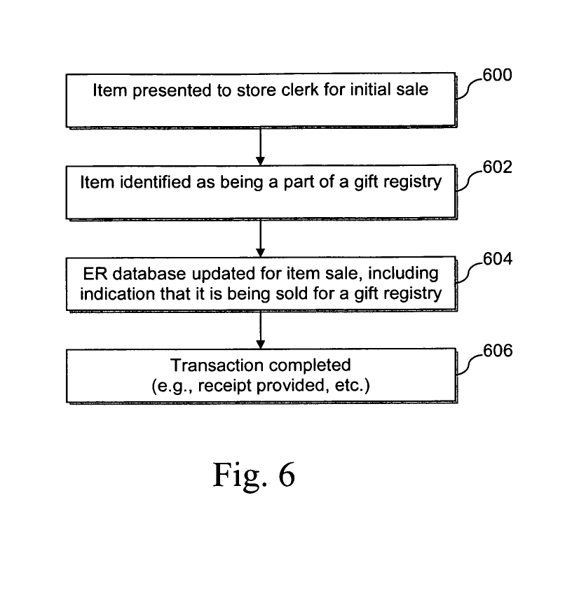

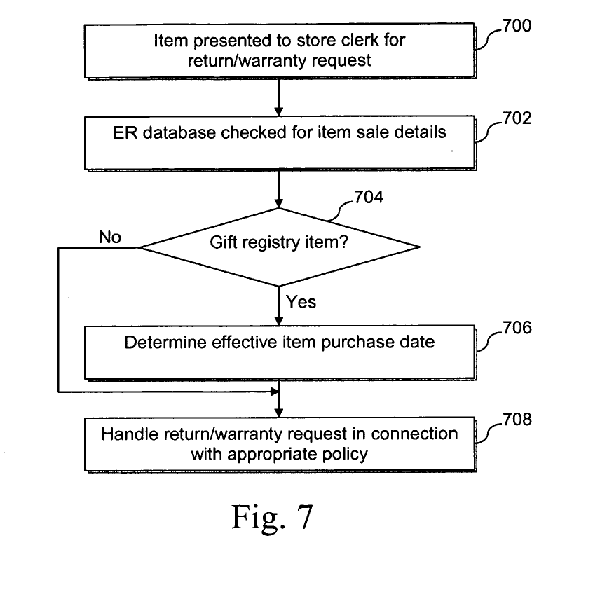

Further illustrative details of the operation of the components in from FIG. 5 and/or other system elements will be provided in connection with the exemplary flowcharts in FIGS. 6-7. In that regard, FIG. 6 is a flowchart that shows an illustrative process for updating an ER database when an item is sold for a gift registry in accordance with certain exemplary embodiments. In step 600, an item is presented to a store clerk for an initial sale. A determination may be made as to whether the item presented for sale is a part of a gift registry in step 602. This determination may include, for example, asking the purchaser to identify the event by name and/or date, by providing a unique identifier of the event (e.g., a unique registry ID number), etc. In one or more steps not shown, the register may consult the gift registry database either directly or indirectly (e.g., through the ER system) to verify that the event is valid, to update the gift registry to reflect that the item has been purchased, etc.

Similarly, in step 604, the ER database may be updated to indicate that the item has been sold. This may include, for example, storing the particular return and/or warranty policy associated with the sold item, as well as a unique identifier of the item (e.g., serial number+UPC, RFID, EPC, etc.), and a sale date of the item. In certain exemplary embodiments, if it is determined that the item is being sold in connection with a gift registry, the ER database may be made to indicate the same. This may involve, for example, updating a record associated with the sold item to update an additional field corresponding to the effective sale date which may, in certain exemplary embodiments, be set to the date of the event (e.g., as determined by means of querying the gift registry database, by having this information specified by the store clerk or other authorized person, etc.). In certain exemplary embodiments, a simple flag may be updated to indicate that the item was sold as a part of a gift registry. This flag may be provided to trigger the ER database to consult the gift registry database upon return/warranty requests, etc., associated with the item. In certain exemplary embodiments, the databases and/or tables therein may be linked together during this or some other related process. In certain exemplary embodiments, however, the sale date in the ER database may simply be replaced with the date of the event. In certain exemplary embodiments, in place of or in addition to a flag, a series of fields may be provided in the database including, for example, gift registry (Yes/No), gift registry (GR) number, etc.

In step 606, the transaction may be completed. This may involve, for example, saving any changes to the database(s), closing any connections thereto, printing a suitable gift receipt, etc. The gift receipt may include a transaction number associated with the sale, a description of the item (e.g., in words and/or with an indication of the UPC+serial number), the actual date of the sale, information pertaining to the event (e.g., the name of the event, the date of the event, the registry ID number, etc.), and/or the like.

Although certain exemplary embodiments may involve providing the ER database with a gift registry number associated with each item purchase or a link thereto, (e.g., in order to provide access the event date and update ER system transaction records), certain exemplary embodiments may not provide any personal information about the registrants to the ER system directly or even indirectly. Instead, in certain exemplary embodiments, return eligibility determinations may be based solely on the registry identifier and the event date. This illustrative technique may be advantageous in terms of promoting the privacy of the purchasers and the registrants. Retailers may in certain exemplary instances offer this enhanced service and expanded return/warranty policy with a reduced amount of risk related to potential fraudulent warranty/returns and while still helping to maintain the anonymity of the purchasers and recipients.

In creating the exemplary linkages described above between the ER system and the registry, certain exemplary embodiments may make it possible to introduce an additional or alternate level of validation. For instance, data such as item serial number, gift registry identifier, transaction number, purchase date, event date, etc., may be linked together at the time of purchase. As explained in greater detail below, purchase date validation may be overridden, e.g., in favor of event date validation, for example, for items uniquely identified by serial number to have been sold as a part of a gift registry.

FIG. 7 is a flowchart that shows an illustrative process for handling a return/warranty request in accordance with certain exemplary embodiments. An item is presented to a store clerk for a return/warranty request in step 700. The ER system is checked to determine item sale details in step 702. This may include, for example, attempting to find a matching record in the ER database for the item presented for return or warranty service based on a unique identifier (e.g., serial number, RFID, EPC, etc.) and retrieving information such as, for example, the sale date, associated return/warranty policy, etc.

In step 704, it is determined whether the item was sold as a part of a gift registry. This process may involve, for instance, consulting the ER database record to determine whether a flag is set indicating that it was sold as a part of a gift registry; querying the gift registry database based on, for example, the unique item identifier, transaction number associated with the sale, the event identifier, etc.; or by another suitable technique. In situations where multiple gift registry databases are accessible, the “correct” gift registry database may be determined, for example, by reference to a unique gift registry database and/or gift registry identifier.

If it is determined that the item was not sold as a part of the gift registry, the return/warranty request may be handled in connection with the appropriate policy in step 708. As indicated above, this may involve simple purchase date validation techniques. If, however, the item was indeed sold as a part of the gift registry, any further information about the sale and/or registry that may be needed to process the return/warranty request may be obtained from the appropriate source (e.g., the ER database and/or the gift registry database). For example, in step 706, the effective purchase data may be determined. The effective purchase date may in certain example instances be the date of the event. This may be true, for example, in illustrative situations like those posited for the sale of items X and Y in FIG. 4. It may not be true, however, in illustrative situations like that posited for the sale of item Z in FIG. 4 and the effective purchase date instead may be the actual sale date. Once the effective purchase date is determined, the return/warranty request may be handled in connection with the appropriate policy using the effective return date in step 708. This type of processing may involve the express or implicit overriding of purchase date validation, e.g., in favor of event date validation where appropriate. Of course, it will be appreciated that the effective sale date may be determined and/or stored in advance, e.g., at the time the product is sold, in batch by the ER system (e.g., acting in concert with the appropriate gift registry database) at scheduled times, etc.

In certain exemplary embodiments, in one or more steps not shown, the person(s) presenting the item sold in connection with the gift registry for return/warranty service may be asked to verify details concerning the event. For example, the person(s) may be asked to confirm information like the event name, event date, etc. This information may be retrieved from the gift registry system directly or through the ER system acting as an intermediary. In addition, or in the alternative, personal information (e.g., regarding the recipient and/or gift-giver) may or may not be verified in different exemplary embodiments. In certain exemplary embodiments, personal information may be checked by interfacing with the gift registry database directly while this personal information is isolated from the ER system for privacy and/or other purposes. In such cases, the ER system may simply await an “accept or reject” signal from an authorized store clerk who has access to this potentially sensitive information. Based on the “accept or reject” signal, the ER database may ultimately send a selective sale date override code to the register. This exemplary arrangement may in certain exemplary instances help reduce the likelihood of fraud, while still protecting personal information, e.g., by keeping it from being directly accessed by the ER system. The information checked may the same as or different from that provided on the gift receipt.

It will be appreciated that the connection between the ER system and gift registries may be advantageous for other purposes. For example, the connection between the ER system and gift registries may be advantageous in connection with product recalls. For a baby registry, for instance, if a particular stroller is recalled (and it is serialized and tracked by the ER system), certain exemplary embodiments may accept a warning notification from a manufacturer, product safety authority such as the Consumer Product Safety Commission (CPSC), or other authorized person or group and notify sellers such as retailers and provide for them the registry IDs for any and all purchasers of the recalled item. The retailer in addition or in the alternative may access the personal contact information of the registrants to notify them about the recall in a targeted and effective manner. In addition, or in the alternative, if such registrant information is not known for example, future potential purchasers could be warned of the recall when browsing the registry, at the time of purchase, etc. The recalled product in certain exemplary instances may simply be removed from the registry and/or a suitable replacement product may be specified, e.g., by the registrant, upon a retailer's or manufacturer's suggestion, etc. Providing this sort of product recall warning may be offered as a value-add service from retailers for gift registries in certain exemplary instances.

Although certain exemplary embodiments have been described in relation to gift registries for weddings, it will be appreciated that the exemplary techniques described herein may be applied to other kinds of gift registries and also goods and services that are sold in advance of the time that they are to be gifted, activated, etc. In general, the exemplary techniques described herein may be applied to any serialized item that may have an associated variable return/warranty policy associated with it and that may be used or activated at a discernable time after its initial sale. For example, the techniques of certain exemplary embodiments may be applied to baby showers, baby births, birthdays, anniversaries, graduations, bar/bat mitzvahs, and/or the like. Although certain exemplary embodiments may be suitable for “special events” with fixed or known future dates, the exemplary embodiments described herein may be modified to work for special events that occur within a known date or time range. For example, although a birthday may be known to be on a particular day, a graduation may be known to be within a certain week or even month. In such cases, the event date may be specified as the beginning, middle, or end date in a specified range. In certain exemplary embodiments, the event date may be calculated as an average or the median of dates entered by purchasers.

Although certain exemplary embodiments described herein have shown and/or described messages being provided on displays, receipt tapes, and/or the like, it will be appreciated that such messages may be provided in different ways, in different formats, and/or on different media. For example, such messages may be provided on a display screen at the POS location for the customer and/or staff member, on a print-out for a POS location staff member, on a customer's receipt, etc. Additionally, although certain exemplary embodiments have been described as relating to serial numbers, it will be appreciated that the techniques described herein may be applied to products identified in different ways, e.g., by EPC, RFID, EAN, JAN, etc.

Additionally, although certain exemplary embodiments have been described in relation to products having serial numbers, the present invention is not so limited. For example, unserialized products may also take advantage of the techniques described herein by virtue of other unique and/or identifiable characteristics thereof. Furthermore, certain products are produced in such limited quantities that their mere existence may be self-authenticating and/or self-identifiable. Additionally, certain products are so tightly controlled that their appearance via other channels may indicate a potential problem worthy of notification to a trusted authority (e.g. the auction house, a manufacturer, a trusted ER intermediary, etc.).

While the systems and methods have been described in connection with what is presently considered to practical and preferred embodiments, it is to be understood that these systems and methods are not limited to the disclosed embodiments, but on the contrary, is intended to cover various modifications and equivalent arrangements included within the scope of the appended claims.

What is claimed is:

1. A method of processing a product at a point-of-sale (POS) location, the method comprising:
receiving a unique identifier of an item presented in connection with a return or warranty request;
locating, in an electronic registration (ER) database of an ER system, a record that corresponds to the presented item, the record indicating an original sale date of the item and an applicable return or warranty policy for the presented item;
determining, based at least in part on the record, whether the presented item was sold in connection with a gift registry;
when it is determined that the presented item was sold in connection with a gift registry, determining whether the presented item qualifies for the return or warranty request using an event date associated with the gift registry rather than the original sale date of the item; and
providing an indication as to whether the presented item qualifies for the return or warranty request.

2. The method of claim 1, further comprising determining whether the presented item qualifies for the return or warranty request using the original sale date of the item when it is determined that the presented item was sold not in connection with a gift registry.

3. The method of claim 1, further comprising determining whether the presented item qualifies for the return or warranty request using the original sale date of the item; and
overriding the determination as to whether the presented item qualifies for the return or warranty request using the original sale date of the item and instead determining whether the presented item qualifies for the return or warranty request using the event date associated with the gift registry rather than the original sale date of the item when it is determined that the presented item was sold in connection with a gift registry.

4. The method of claim 3, wherein said overriding is practiced only when the original sale date of the item is earlier in time than the event date associated with the gift registry.

5. The method of claim 1, wherein the determining of whether the presented item was sold in connection with the gift registry is practiced by consulting a gift registry database identified in the record.

6. The method of claim 5, wherein the gift registry database is separate form the ER database.

7. The method of claim 6, wherein personal information regarding the item recipient(s) and the purchaser(s) of the item is not provided to the ER database.

8. A method of processing a product at a point-of-sale (POS) location, the method comprising:
receiving a unique identifier of an item presented in connection with a return or warranty request, the item having been previously sold in connection with a gift registry;
receiving a registry identifier associated with the gift registry;
locating, in an electronic registration (ER) database of an ER system, a first record that corresponds to the presented item, the first record indicating an applicable return or warranty policy for the presented item;
locating, in a gift registry database, a second record indicating an event date based on the registry identifier;
determining whether the presented item qualifies for the return or warranty request using the event date and the applicable return or warranty policy for the presented item; and
providing an indication as to whether the presented item qualifies for the return or warranty request.

9. The method of claim 8, further comprising overriding a determination as to whether the presented item qualifies for the return or warranty request based on sale date validation and instead using the determination as to whether the presented item qualifies for the return or warranty request using the event date and the applicable return or warranty policy for the presented item.

10. The method of claim 9, wherein said overriding is practiced only when the sale date of the item is earlier in time than the event date.

11. The method of claim 8, wherein the gift registry database is separate form the ER database.

12. The method of claim 11, wherein personal information regarding the item recipient(s) and the purchaser(s) of the item is not provided to the ER database.

13. A product return/warranty validation system, comprising:
an electronic registration (ER) system including programmed logic circuitry and an ER database, the ER database storing records corresponding to sold items, each said record indicating an original sale date of the item and an applicable return or warranty policy for the item;
wherein the programmed logic circuitry is configured to:
(a) receive a unique identifier of an item presented in connection with a return or warranty request,
(b) locate, in the ER database, a record that corresponds to the presented item,
(c) determine, based at least in part on the record, whether the presented item was sold in connection with a gift registry, and
(d) when it is determined that the presented item was sold in connection with a gift registry, further determine whether the presented item qualifies for the return or warranty request using an event date associated with the gift registry rather than the original sale date of the item.

14. The product return/warranty validation system of claim 13, further comprising a register configured to send the unique identifier to the programmed logic circuitry of the ER system and receive an indication from the ER system as to whether the presented item qualifies for the return or warranty request.

15. The product return/warranty validation system of claim 13, wherein the programmed logic circuitry of the ER system is further configured to determine whether the presented item qualifies for the return or warranty request using the original sale date of the item when it is determined that the presented item was sold not in connection with a gift registry.

16. The product return/warranty validation system of claim 13, wherein the programmed logic circuitry of the ER system is further configured to:
determine whether the presented item qualifies for the return or warranty request using the original sale date of the item, and
override the determination as to whether the presented item qualifies for the return or warranty request using the original sale date of the item and instead determining whether the presented item qualifies for the return or warranty request using the event date associated with the gift registry rather than the original sale date of the item when it is determined that the presented item was sold in connection with a gift registry.

17. The product return/warranty validation system of claim 16, wherein said overriding is performed only when the original sale date of the item is earlier in time than the event date associated with the gift registry.

18. The product return/warranty validation system of claim 13, wherein the determining of whether the presented item was sold in connection with the gift registry is practiced by consulting a gift registry database identified in the record.

19. The product return/warranty validation system of claim 18, wherein the gift registry database is separate form the ER database.

20. The product return/warranty validation system of claim 19, wherein personal information regarding the item recipient(s) and the purchaser(s) of the item is not provided to the ER database.

21. A product return/warranty validation system, comprising:
an electronic registration (ER) system including programmed logic circuitry and an ER database, the ER database storing records corresponding to sold items, each said record indicating an original sale date of the item and an applicable return or warranty policy for the item;
wherein the programmed logic circuitry is configured to:
(a) receive a unique identifier of an item presented in connection with a return or warranty request, the item having been previously sold in connection with a gift registry,
(b) receive a registry identifier associated with the gift registry,
(c) locate, in the ER database, a first record that corresponds to the presented item,
(d) locate, in a gift registry database, a second record indicating an event date based on the registry identifier, and
(e) determine whether the presented item qualifies for the return or warranty request using the event date and the applicable return or warranty policy for the presented item.

22. The product return/warranty validation system of claim 21, wherein the gift registry database is separate form the ER database.

23. The product return/warranty validation system of claim 22, wherein personal information regarding the item recipient(s) and the purchaser(s) of the item is not provided to the ER database.
